(19) United States
(12) Patent Application Publication
(10) Pub. No.: US 2008/0153317 A1
(43) Pub. Date: Jun. 26, 2008

(54) Fabric Interfacing Architecture For A Node Blade

(76) Inventors: Ping-Hai Hsu, Hsinchu (TW); Yen-Liang Liu, Taipei (TW); Kuo-Pao Fan, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/751,035

(22) Filed: May 21, 2007

(30) Foreign Application Priority Data
Dec. 26, 2006 (TW) 095149005

(51) Int. Cl. H01R 12/00

(52) U.S. Cl. 439/61

(57) ABSTRACT

Disclosed is a fabric interfacing architecture for a node blade. The fabric interfacing architecture comprises a fabric interface unit and a control unit. The fabric interface unit includes a switch and an E-keying element. The control unit receives control signals from an external web server to control the fabric interface unit. The control unit respectively controls the switch and the E-keying element through different control signals. The fabric interfacing architecture is utilized together with a back plane of a shelf and one or more physical layers of the node blade. This allows flexible PHY-to-Channel/Port routings, thereby achieving the support for multiple topology modes. The invention may on-line adjust the assignments of communication channels and ports according to the needs for physically applied bandwidths, which optimizes the bandwidth utilization.

### FIELD OF THE INVENTION

The present disclosure relates generally to a fabric interfacing architecture for a node blade, and can be used in combination with node blade and chassis backplane.

### BACKGROUND OF THE INVENTION

As a variety of network applications and services grow rapidly, the high speed, predictable, reliable, and interruption-free network service is becoming a requirement for most corporate and individual clients. Therefore, the future network services, such as VoIP, video conferencing, multimedia entertainment, and corporate EDA, is likely to rely on a reliable network architecture to support the stable connection and predictable performance.

Therefore, it stays as a major challenge for network, facility and service providers to improve the availability of the overall network infrastructure and its constituting components, such as wiring (fiber optical, copper cable, etc.), telecom facility (switch, router, etc.) and administrative systems (configuration management software, bandwidth management software, etc.), even raising the availability to as high as 99.999% as in the telecommunication industry.

FIG. 1 shows a framework of a telecom-grade network facility or server. As shown in FIG. 1, a fiber network facility 101 is connected through a fiber-to-the-home (FTTH) terminal 102 to a remote switch 103 of asynchronous transfer mode (ATM) or an IP router 104. A cable network facility 105 is connected to a cable modem termination system (CMTS) server 106. A copper loop network facility 107 is connected through a digital subscriber line access multiplexer (DSLAM) 108 to a remote network.

This type of network is usually based on proprietary architecture. Different types of network facilities are connected to different servers. As the demands of short deployment time and cost, and high availability, the open standard architecture is becoming a new trend. One of the hardware specifications for the chassis with an open architecture is the Advanced Telecom Computing Architecture (ATCA) defined by PCI Industry Computer Manufactures Group (PICMG). This specification is for high bandwidth, high reliability, next generation communication, and computer platform.

ATCA covers a series of specifications (PICMG 3.x), including PICMG3.0 and other subsidiary specifications. PICMG3.0 is the core specification. PICMG3.0 defines the architecture, power supply, heat dissipation, interconnection, and system administration of the ATCA series. The subsidiary specifications define the transmission method of the interconnection defined in the core specification. Currently, there are five subsidiary specifications, including 3.1 Ethernet, 3.2 InfiniBand, 3.3 Star Fabric, 3.4 PCI Express and 3.5 RapidIO.

The Open architecture based on ATCA standard is an important trend in the communication industry. For example, the Internet service providers, such as NTT DoCoMo of Japan, KT of South Korea, begin to use ATCA as the common platform for different application services and network infrastructure. However, in many practices, only the network facilities are modified to be ATCA compatible, a real common platform for multiple services and applications is still not yet to be realized.

In addition to the differences in functionality and interface requirements for various applications and services, the topology and data bandwidth of the system architecture are also different. To make ATCA platform meet the needs of different applications and services, the exchange interface of an ATCA platform can support a plurality of topologies in a hardware case. The ideal situation is that the exchange interface of a node blade of an ATCA can be adjustable to different topology modes for different system topology and bandwidth requirements.

However, the node blade of a conventional ATCA usually supports only for a single topology interface, such as full-mesh topology, single-star topology, dual-star topology, dual-dual-star topology. Although few ATCA node blades support multi-topology interface, the use of communication channel and port in each topology mode is fixed and not adjustable.

The definition of “port” and “channel” are as follows. A port includes the minimal differential pairs defined in the specification for interconnect transmission technology. For example, for PICMG3.x specification, a port of a fabric channel includes two differential pairs. The ON/OFF of each port can be controlled by an individual E-keying element.

A channel includes one or more ports. All these ports in one channel are used for connecting two slots, and are acting as the data transmission path in a physical layer between these two slots. In general, the more ports a channel has, the more bandwidth the channel has, and the channel can transmit more data.

### SUMMARY OF THE INVENTION

An exemplary example consistent with the invention provides a fabric interfacing architecture for a node blade. The fabric interfacing architecture for a node blade enables an ATCA node blade to support multi-topology fabric interface, and can be used for adjusting the bandwidth used by each channel of the fabric interface.

An exemplary example consistent with the invention of a fabric interfacing architecture for a node blade used in combination with a chassis backplane and a plurality of physical layers of a node blade is disclosed, the architecture comprising: a fabric interfacing unit; and a control unit, the fabric interfacing unit including a switch and an E-keying element, the switch being connected respectively to each physical layer of the node blade and being coupled to the E-keying element, the E-keying element connected to an interface of the chassis backplane, the control unit connected to the switch and the E-keying element through a plurality of control lines.

An exemplary example consistent with the invention of a method of using a node blade in combination with a chassis backplane and a plurality of physical layers of the node blade is disclosed, the method comprising: connecting a switch of a fabric interfacing unit respectively to each physical layer of the node blade; connecting an E-keying element of the fabric interfacing unit to an interface of case backplane; and configuring an enabling and disabling of connection between the fabric interfacing unit and the chassis backplane through a control unit.

It is to be understood that both the foregoing general description and the following detailed description are exemplary and explanatory examples only and are not restrictive of the invention, as claimed.

### BRIEF DESCRIPTION OF THE DRAWINGS

FIG. 1 shows a framework of a telecom-grade network facility or server.

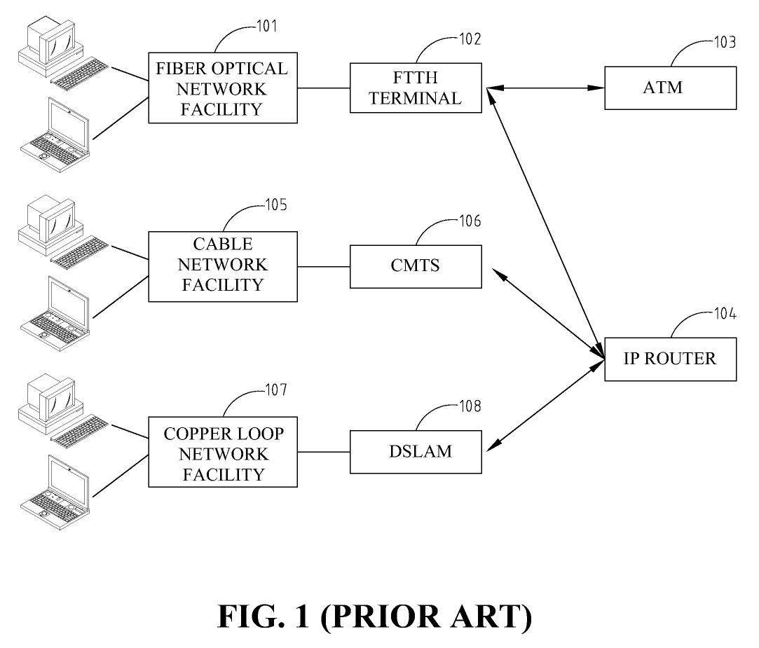

FIG. 2 shows an exemplary schematic view of a fabric interfacing architecture for node blade, consistent with the invention.

FIG. 3 shows a first exemplary example illustrating a node blade, consistent with the invention connected to an ATCA system.

FIG. 4 shows a second exemplary example illustrating a node blade, consistent with the invention connected to an ATCA system, and the bandwidths among other node blades are unequal.

FIG. 5 shows a third exemplary example illustrating a node blade, consistent with the invention connected to an ATCA system in a dual-star topology mode.

FIG. 6 shows a fourth exemplary example illustrating a node blade, consistent with the invention connected to an ATCA system in a hybrid topology mode.

FIG. 7 shows a diagram of an exemplary method of using a node blade, consistent with the invention in combination with a chassis backplane and a plurality of physical layers of the node blade.

### DETAILED DESCRIPTION OF THE PREFERRED EMBODIMENTS

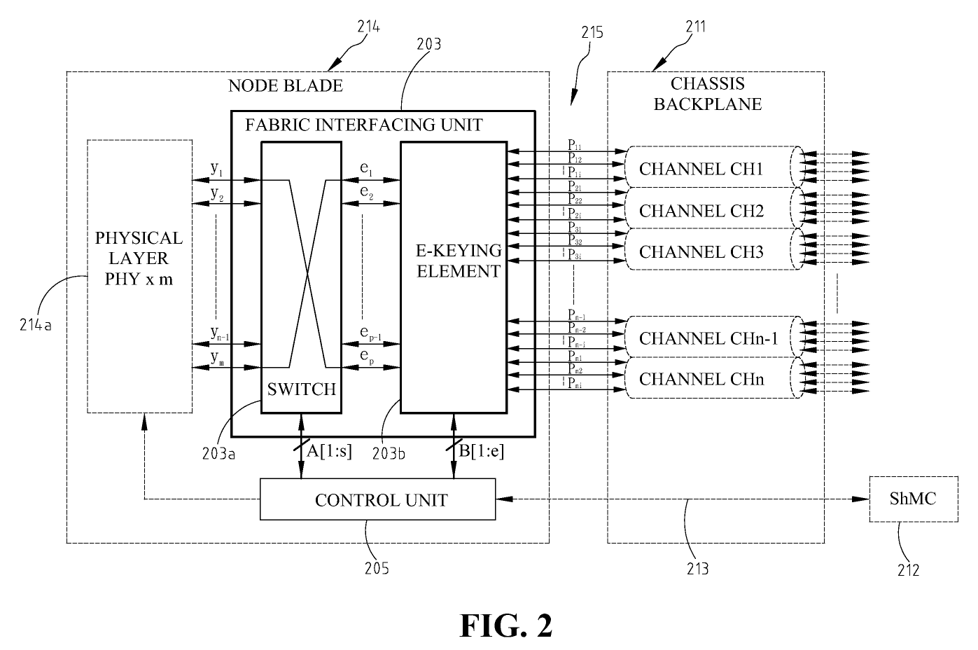

FIG. 2 shows an exemplary schematic view of a fabric interfacing architecture for node blade, consistent with the invention. As shown in FIG. 2, the fabric interfacing architecture for node blade is used in combination with a chassis backplane 211 and a plurality of physical layers 214a of a node blade 214. The fabric interfacing architecture provides the connection mapping between m physical layers 214a of node blade 214 and ports P₁₁-P₁ᵢ, . . . , Pₙ₁-Pₙᵢ of n channels CH1-CHn of the chassis backplane 211.

The fabric interfacing architecture for node blade includes a fabric interfacing unit 203 and a control unit 205. The fabric interfacing unit 203 includes a switch 203a, and an E-keying element 203b. The control unit 205 controls the switch 203a and the E-keying element 203b through control signals A[1:s] and B[1:e].

The switch 203a is connected respectively to each physical layer and the E-keying element 203b of the node blade 214. The E-keying element 203b is connected to an interface 215 of the chassis backplane 211. The interface 215 includes at least ports P₁₁-P₁ᵢ, . . . , Pₙ₁-Pₙᵢ of n channels CH1-CHn of the chassis backplane 211.

The m physical layers 214a of the node blade 214 are connected to the switch 203a through signals y₁-yₘ, respectively. Each signal yⱼ includes the minimal differential pairs specified by the used interconnection transmission technology, and is mapped to a port. The control unit 205 controls the connection mapping between signals y₁-yₘ of the switch 203a and eᵢ-eₚ through control signals A[1:s], and outputs signals eᵢ-eₚ to the E-keying element 203b.

Similarly, each signal eₖ also includes the minimal differential pairs specified by the used interconnection transmission technology, and is mapped to a port. The E-keying element 203b is an ON/OFF control element for enable or disable the interface 215 between the node blade 214 and the chassis backplane 211, such as an ATCA backplane. The control unit 205 controls the connection mapping between input signals e₁-eₚ and the interface of the chassis backplane 211 through control signals B[1:e].

For example, the PICMG3.x specification defines the transmission protocol between the channels, where each channel includes four ports and each port includes two differential pairs. In other words, a port has two differential pairs and four ports make a channel.

Take ATCA system as an example. PICMG association defines five different specifications, and these five specifications are not identical in terms of transmission protocols used in the data exchange interface. Therefore, the blades of different specifications are not compatible. In system initialization, an ShMC 212 of the system determines whether the data interfaces between the node blades or between the node blade and the exchange card are compatible, in order to decide the enabling of the ports of the channel of the node blade. Furthermore, even if the type of data interfaces is compatible, the numbers of the ports and channels of each blade may not be same. All these determine the enabling or disabling of the port of the channel for the node blade. The control unit receives the control signals from an external shelf manager control unit (ShMC), and controls the switch and the E-keying element through the control signals.

Therefore, the ShMC 212 controls the control unit 205 of the node blade 214 in an online and real-time way through IPMB 213 to determine the connection mapping between the physical layer element 214a of the node blade 214 and the ports P₁₁-P₁ᵢ, . . . . Pₙ₁-Pₙᵢ of n channels CH1-CHn of the chassis backplane 211, and decides which ports are enabled. Therefore, the channel bandwidth for data exchange between the node blades or between the node blade and the exchange card can be dynamically adjusted. The bandwidth of each channel depends on the transmission protocol, and the bandwidth range is between 1 Gbps and 10 Gbps.

By using the ShMC 212 through the IPMB 213 to adjust and control the configuration of the control unit 205 of the node blade 214 so that the configuration of the control unit 205 is highly flexible. Therefore, the control unit 205 can control fabric interfacing unit 203 through software, and the configuration of the node blade 214 can be changed online to support multi-topology modes without rebooting or manual replacement.

With the fabric interfacing unit 203 and the control unit 205 of the node blade 214, the flexibility of the route connection between the physical layer 214a of the node blade 214 and the physical layer of ports P₁₁-P₁ᵢ, . . . , Pₙ₁-Pₙᵢ of channels CH1-CHn is improved, as well as supports the communication servers connected by using multi-topology modes, including full mesh, dual-star, dual-dual star, replicate mesh or hybrid topologies. Furthermore, the distribution of the ports of the channels of the chassis backplane 214 to optimize the bandwidth utilization according to the bandwidth demand is adjusted.

The following examples consistent with the invention describe how to apply the invention to a chassis backplane and a node blade to support multi-topology modes. Without loss of generality, the facilities are integrated on an ATCA platform, including the node blade being an ATCA card, and the chassis backplane being an ATCA backplane.

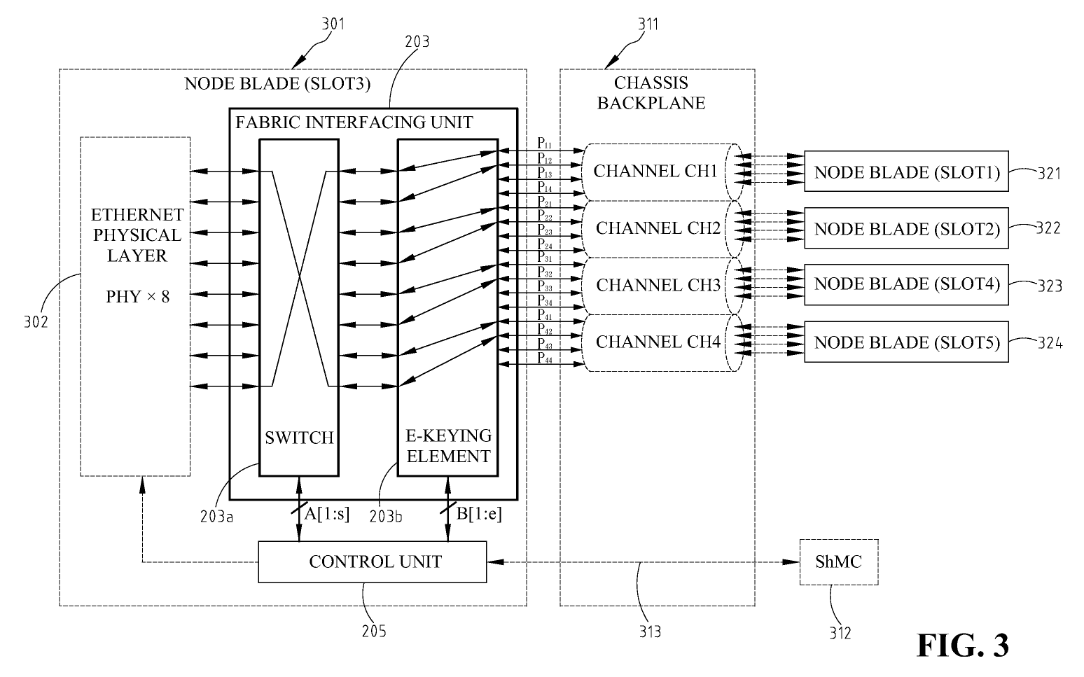

FIG. 3 shows a first exemplary example illustrating a node blade consistent with the invention connected to an ATCA system. The ATCA chassis supports a full mesh topology of five slots, slot1-slot5. The full mesh topology for the chassis backplane includes four channels Ch1-Ch4, with each channel having four ports, P₁₁-P₁₄, P₂₁-P₂₄, P₃₁-P₃₄, and P₄₁-P₄₄, respectively. Node blade 301 is in slot3 of the chassis backplane 311. The node blade 301 includes 8 Ethernet physical layers 302, and the fabric interfacing unit 203 and the control unit 205.

In the first exemplary example, the node blade 301 is connected to the ATCA backplane 311 in a full mesh topology mode, and controls the control unit 205 of the node blade 301 through ATCA ShMC 312 and IPMB 313 so that the eight Ethernet physical layers 302 of the node blade 301 can connect respectively to CH1/P₁₁-P₁₂, CH2/P₂₁-P₂₂, CH3/P₃₁-P₃₂, and CH4/P₄₁-P₄₂ through the fabric interfacing unit 203.

As each channel of the five slots of ATCA system uses two ports, the bandwidth between the node blade 301 of slot3 and the node blades 321-324 in other slots (slot1, slot2, slot4, slot5) are equally distributed. The bandwidth of the node blade in the ATCA slot and the other slots can also be non-equally distributed, and can be adjusted according to the bandwidth demands. The following two examples describe the scenarios.

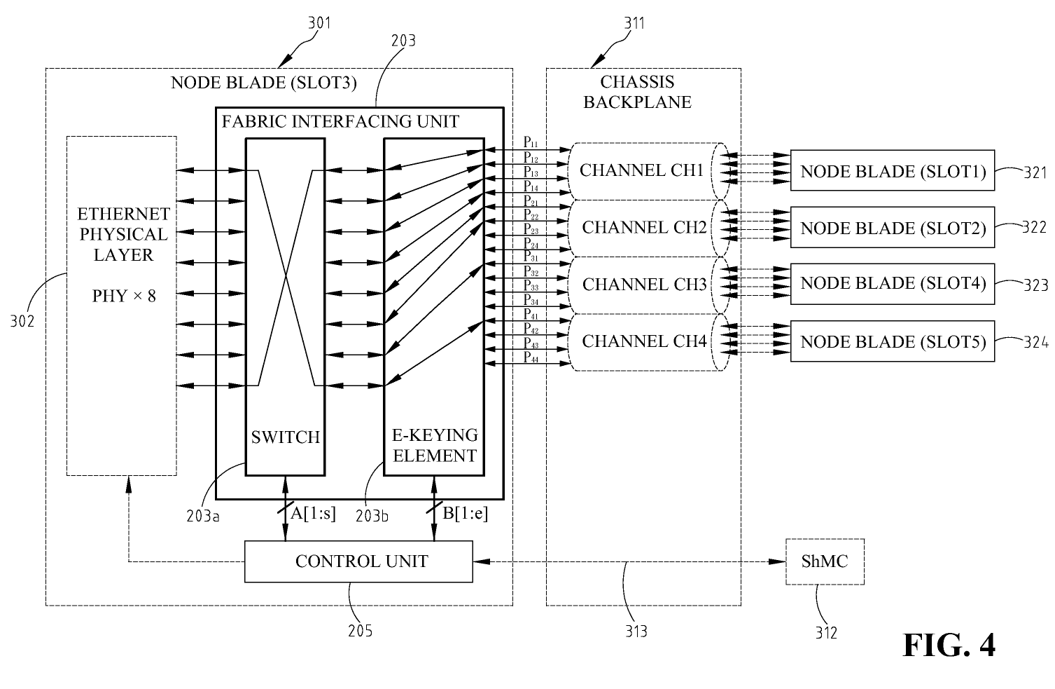

FIG. 4 shows a second exemplary example illustrating a node blade consistent with the invention connected to an ATCA system, and the bandwidths among other node blades are unequal. The architecture of the node blade and ATCA is identical to that of FIG. 3. In this example, when an application, such as real-time video service, needs more communication bandwidth between the node blade 301 and the node blade in slot1. The control unit 205 of the node blade 301 uses software to control the fabric interfacing unit 203 so that the eight Ethernet physical layers 302 on the node blade 301 are connected through the fabric interfacing unit 203 to CH1/P₁₁-P₁₄, CH2/P₂₁-P₂₂, CH3/P₃₁, and CH4/P₄₁, respectively. Hence, the node blade 301 has four ports on channel CH1 with bandwidth as high as 10 Gbps. Also, the node blade on slot1 may execute the corresponding configuration.

As each channel of the five slots of ATCA system uses two ports, the eight Ethernet physical layers 302 of the node blade on slot3 uses 4 ports in CH1, 2 ports in CH2, 1 port in CH3, and 1 port in CH4 to connect to the ATCA backplane. Therefore, the bandwidth distribution of the external interfaces of node blade 301 of slot3 is very different among blade nodes 321-324 of other slots.

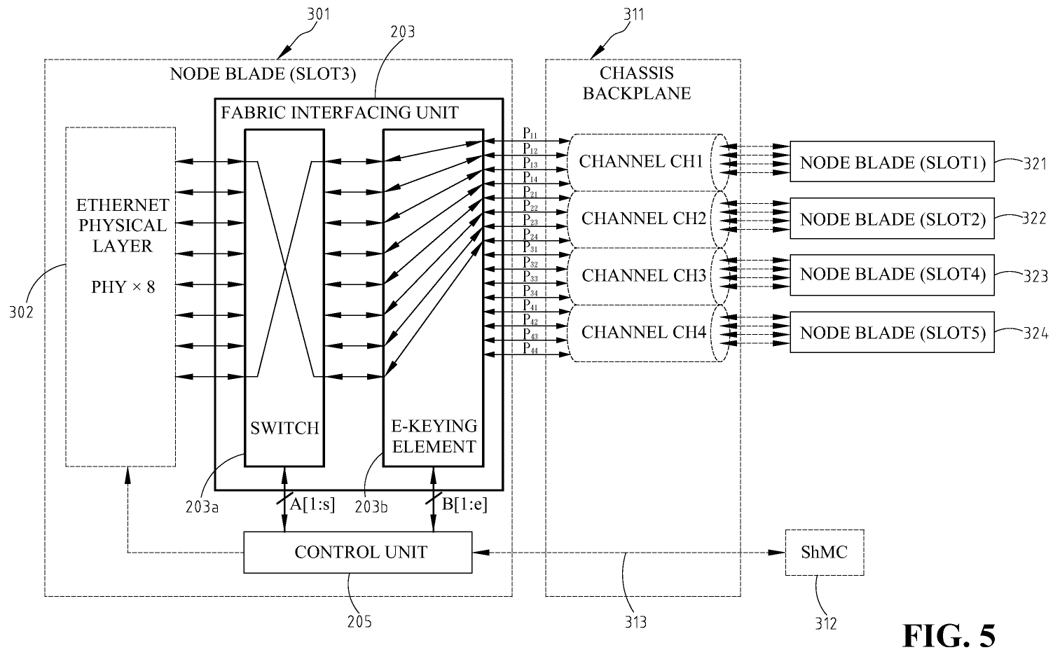

FIG. 5 shows a third exemplary example illustrating a node blade consistent with the invention connected to an ATCA system in a dual-star topology mode. The architecture of the node blade and ATCA is identical as that of FIG. 3. In FIG. 3, the exemplary node blade 301 is connected to ATCA backplane in a full mesh topology mode; that is, the eight Ethernet physical layers 302 of the node blade 301 can connect respectively to CH1/P₁₁-P₁₂, CH2/P₂₁-P₂₂, CH3/P₃₁-P₃₂, and CH4/P₄₁-P₄₂ through the fabric interfacing unit 203.

In the third exemplary example, the ATCA ShMC 312 controls the control unit 205 of the node blade 301 through the IPMB 313. The control unit 205 may real-time changes the configuration of the fabric interfacing unit 203 via software method. The eight Ethernet physical layers 302 of the node blade 301 change to connect respectively to CH1/P₁₁-P₁₄, CH2/P₂₁-P₂₄ without rebooting ATCA system. Hence, the node blade can change from supporting full mesh topology mode to supporting dual-star topology mode.

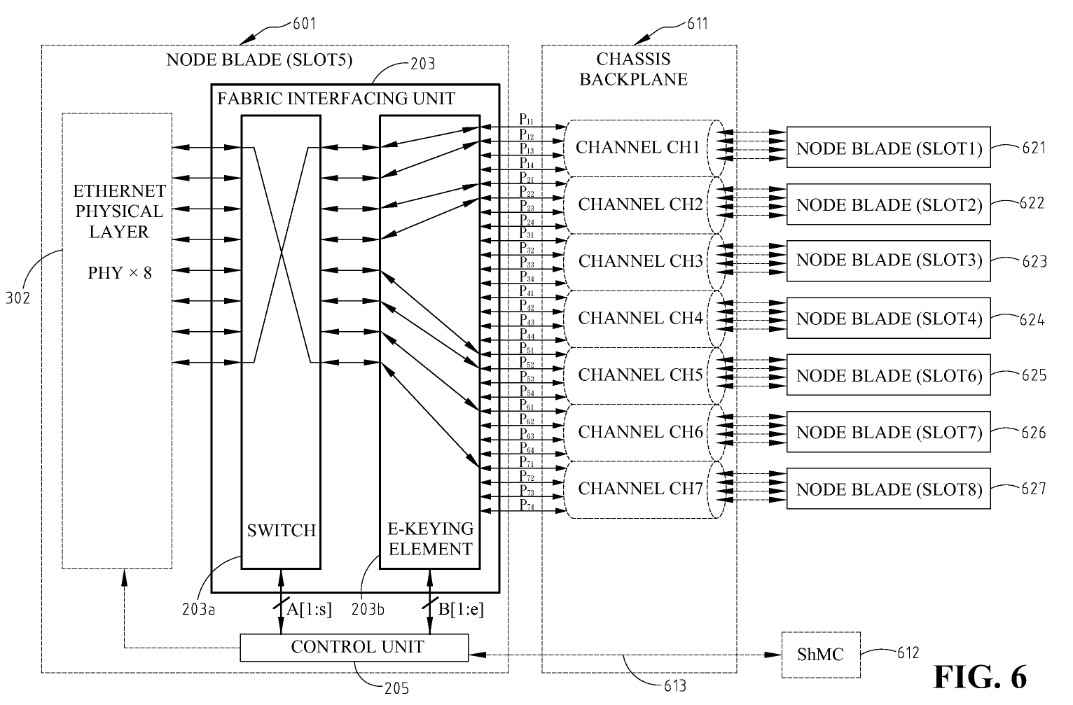

FIG. 6 shows a fourth exemplary example illustrating a node blade consistent with the invention connected to an ATCA system in a hybrid topology mode. As shown in FIG. 6, the ATCA chassis supports an 8-slot full mesh topology connection. The chassis backplane includes 7 channels CH1-CH7 in a full mesh topology, with each channel using four ports. Therefore, the 7 channels use ports P₁₁-P₁₄, P₂₁-P₂₄, P₃₁-P₃₄, P₄₁-P₄₄, P₅₁-P₅₄, P₆₁-P₆₄, and P₇₁-P₇₄, respectively. The node blade 601 is in slot5 of ACTA backplane 611, and has eight Ethernet physical layers 302, and the fabric interfacing unit 203 and the control unit 205.

In the fourth exemplary example, the ATCA ShMC 612 controls the control unit 205 of the node blade 601 through the IPMB 613. The control unit 205 may real-time changes the configuration of the fabric interfacing unit 203 via software method. The eight Ethernet physical layers 302 of the node blade 601 change to connect respectively to CH1/P₁₁-P₁₂, CH2/P₂₁-P₂₂, CH5/P₅₁-P₅₂, CH6/P₆₁, and CH7/P₇₁ without rebooting ATCA system.

In this ATCA system, the node blade is in slot5. Therefore, the node blade 601 in slot5 and the node blades 621-624 in slot1-slot4 are connected in a dual-star topology mode. The node blade 601 in slot5 and the node blades 625-627 in slot6-slot8 are connected in a full mesh topology mode. Hence, the node blade 601 achieves the object of supporting a hybrid topology mode. In other words, the exemplary architecture can support multi-topology modes and optimize the bandwidth utilization.

According to exemplary examples consistent with the invention, when the system is initialized, the ShMC of the system may control the control unit of the node blade in an online and real-time way through the Intelligent Platform Management Bus (IPMB). The control unit controls the fabric interfacing unit to determine the interconnection relation between the physical layer elements of the node blade and the ports of the channels of the chassis backplane interface. Hence, the data path and its bandwidth between the node blade and others are adjusted dynamically.

The exemplary embodiment uses ShMC through IPMB to adjust and control the configuration of the control unit of the node blade so that the configuration of the control unit could be very flexible. The node blade configuration can be changed online to support multi-topology modes without rebooting or manual replacement.

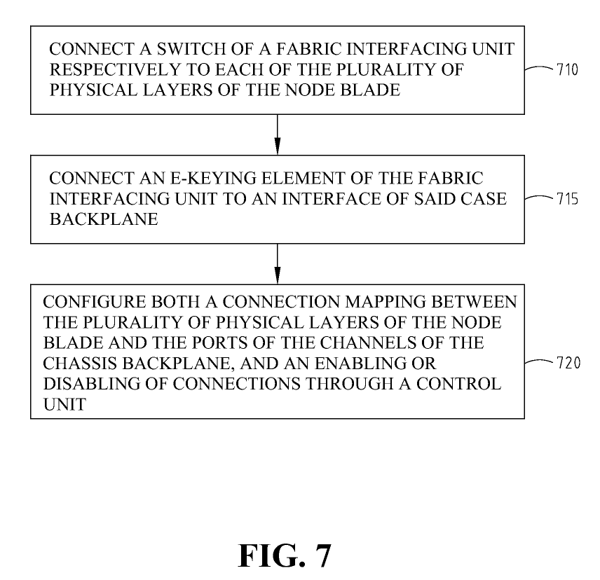

FIG. 7 shows a diagram of an exemplary method of using a node blade, consistent with the invention in combination with a chassis backplane and a plurality of physical layers of the node blade. Referring now to FIG. 7, the exemplary method may connect a switch of a fabric interfacing unit respectively to each of the plurality of physical layers of the node blade (step 710), and may connect an E-keying element of the fabric interfacing unit to an interface of said case backplane (step 715). The exemplary method may configure both a connection mapping between the plurality of physical layers of the node blade and the ports of the channels of the chassis backplane, and an enabling or disabling of connections through a control unit (step 720).

As discussed above, the control unit may be connected to the switch and the E-keying element through a plurality of control lines. A connection mapping may further be provided between said physical layers of the node blade and the ports of the channels of the chassis backplane through the fabric interfacing unit. The bandwidth of the node blade can be adjusted dynamically.

Although exemplary examples have been described consistent with the invention, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A fabric interfacing architecture for a node blade, used in combination with a chassis backplane and a plurality of physical layers of a node blade, said architecture comprising:
a fabric interfacing unit, including a switch and an E-keying element, said switch being connected respectively to each of said plurality of physical layers of said node blade and being coupled to said E-keying element, said E-keying element connected to an interface of said case backplane; and
a control unit, connected to said switch and said E-keying element through a plurality of control lines.

2. The architecture as claimed in claim 1, wherein the interface of said chassis backplane includes at least a channel and at least a port.

3. The architecture as claimed in claim 2, wherein said control unit configures the enabling and disabling of the connections between said E-keying element and each said port of each said channel of said chassis backplane.

4. The architecture as claimed in claim 1, wherein said control unit controls said fabric interfacing unit through software.

5. The architecture as claimed in claim 1, wherein the bandwidth of said node blade is dynamically adjustable.

6. The architecture as claimed in claim 1, wherein said node blade is an Advanced Telecom Computing Architecture (ATCA) card.

7. The architecture as claimed in claim 1, wherein said fabric interfacing unit provides connection mapping between said physical layers of said node blade and said ports of said channels of said chassis backplane.

8. The architecture as claimed in claim 1, wherein said node blade supports multi-topology modes of connection.

9. The architecture as claimed in claim 8, wherein said multi-topology modes includes at least one of full mesh, dual star, dual-dual star, replicate mesh topology or hybrid topology.

10. The architecture as claimed in claim 1, wherein said chassis backplane is an ATCA backplane.

11. A method of using a node blade in combination with a chassis backplane and a plurality of physical layers of a node blade, comprising:
connecting a switch of a fabric interfacing unit respectively to each of said plurality of physical layers of said node blade;
connecting an E-keying element of the fabric interfacing unit to an interface of said case backplane; and
configuring an enabling and disabling of connections between the fabric interfacing unit and the chassis backplane through a control unit.

12. The method as claimed in claim 11, the method further includes a step of connecting said control unit to said switch and said E-keying element through a plurality of control lines.

13. The method as claimed in claim 11, the method further includes a step of controlling said fabric interfacing unit by said control unit through software.

14. The method as claimed in claim 11, the method further includes a step of adjusting dynamically the bandwidth of the node blade.

15. The method as claimed in claim 11, the method further includes a step of providing a connection mapping between said physical layers of said node blade and said ports of said channels of said chassis backplane through said fabric interfacing unit.

16. The method as claimed in claim 11, the method further includes a step of using an Advanced Telecom Computing Architecture (ATCA) card as said node blade.

17. The method as claimed in claim 11, the method further includes a step of using an ATCA backplane as said chassis backplane.
